(19) United States
(12) Patent Application Publication
(10) Pub. No.: US 2025/0320975 A1
(43) Pub. Date: Oct. 16, 2025

(54) SOLAR ATMOSPHERE LAMP WITH SPEAKER

(71) Applicant: Shenzhen Forever Electronics Co., LTD., Shenzhen (CN)

(72) Inventors: XIUBO YANG, Dazhou (CN); HUIPING ZHOU, Weinan (CN)

(21) Appl. No.: 18/643,728

(22) Filed: Apr. 23, 2024

(30) Foreign Application Priority Data
Apr. 11, 2024 (CN) 202420767802.4

(51) Int. Cl. F21L 4/08; F21V 19/00; F21V 23/00; F21V 23/04; F21V 31/00; F21V 33/00; F21Y 101/00; F21Y 115/10; H04R 1/02

(52) U.S. Cl. CPC F21L 4/08; F21V 19/0035; F21V 23/008; F21V 23/0414; F21V 31/005; F21V 33/0056; H04R 1/028; F21Y 2101/00; F21Y 2115/10

(57) ABSTRACT

A solar atmosphere lamp with a speaker is provided, which includes: a support seat, a lamp body, a solar cell assembly, and a speaker. The support seat includes a connection frame and a housing, the lamp body is provided with a support platform and a luminous component. The solar cell assembly is provided with a solar panel and a rechargeable battery, the lamp body is connected to the connection frame. The solar cell assembly and the speaker are installed on the housing, the rechargeable battery is connected to the solar panel for charging and supplying energy to the luminous component to emit light and the speaker to play sound. By adding a speaker, the experience is further enhanced from an auditory aspect, achieving a goal of creating an atmosphere from both visual and auditory aspects, enhancing the user's atmosphere experience.

### CROSS-REFERENCE TO RELATED APPLICATIONS

This application claims priority to Chinese Patent Application No. 202420767802.4, filed on Apr. 11, 2024, which is hereby incorporated by reference in its entirety.

### TECHNICAL FIELD

The present disclosure relates to the field of landscape light technologies, and in particular, to a solar atmosphere lamp with a speaker.

### BACKGROUND

The existing solar atmosphere lamps mainly start from a visual aspect, create an atmosphere by designing various exquisite exterior shapes of the lamp body and displaying different lighting effects. However, a lack of auditory assistance reduces the experience. Therefore, the present disclosure proposes a new solution.

### SUMMARY

The purpose of the present disclosure is to provide a solar atmosphere lamp with a speaker, which adopts a structural design by adding a speaker to create an atmosphere from both visual and auditory aspects. It not only enhances the use's atmosphere experience, but also simplifies a control of the solar atmosphere lamp and achieves energy saving effects.

Based on this, the present disclosure provides a solar atmosphere lamp with a speaker, including:
a support seat, which includes a connection frame and a housing, the housing is connected to the connection frame, the connection frame is connected to an insertion rod to stabilize the support seat;
a lamp body, which is provided with a support platform and a luminous component, the support platform is configured to install the luminous component, and the lamp body is connected to the connection frame;
a solar cell assembly, which is connected to the housing, and the solar cell assembly is provided with a solar panel and a rechargeable battery, the rechargeable battery is connected to the solar panel for charging;
a speaker, which is connected to the housing for playing sound.

The solar atmosphere lamp with a speaker as described above, the lamp body further includes a header pip platform and a protective tube, the support platform is fixedly connected to the protective tube, the protective tube is fixedly connected to the header pip platform, and the header pip platform is fixedly connected to the support seat to maintain a connection position of the lamp body to be stable.

The solar atmosphere lamp with a speaker as described above, the housing can be detachably connected to the connection frame so that the housing can be folded and stored.

The solar atmosphere lamp with a speaker as described above, the connection frame is provided with a connecting platform and a connecting column, where the connecting column is provided with a first through hole and a wire slot, a lower of the first through hole is provided with a stabilizing block, the wire slot is configured for connecting wires of the luminous component to access, and the connecting platform is fixedly connected to the connecting column.

The solar atmosphere lamp with a speaker as described above, the connecting platform is provided with a connecting column, a connecting lock column, and a locking component; the connecting column is provided with a locking column hole, and the connecting lock column is connected to the connecting platform through the locking column hole, the connecting lock column is locked by the locking component to fix the housing.

The solar atmosphere lamp with a speaker as described above, the housing includes an upper housing and a lower housing, and a wire hole; the upper housing is connected to the connecting platform, the lower housing is fixedly connected to the upper housing, and the wire hole is configured for connecting wires of lamp beads to access.

The solar atmosphere lamp with a speaker as described above, the upper housing is provided with a solar panel groove, a connecting end column, a battery groove, and a fixing column; the solar panel is fixedly connected to the solar panel groove, the rechargeable battery is detachably connected to the battery groove, a control component is fixedly connected to the upper housing through the fixing column, and the connecting end column is provided with a second through hole, the second through hole can be hinged to the connection frame through the connecting lock column.

The solar atmosphere lamp with a speaker as described above, the lower housing is provided with a speaker slot, a battery clamp block, and a switch slot; the speaker is fixedly installed in the speaker slot, the battery clamp block can further fix the rechargeable battery in the battery groove.

The solar atmosphere lamp with a speaker as described above, the luminous component and the speaker are controlled to emit light and play sound by the control component, the control component is provided with an operation switch that is installed in the switch slot.

The solar atmosphere lamp with a speaker as described above, the operation switch is provided with a waterproof film.

The embodiments of the present disclosure have the following beneficial effects:

1. This solution adopts a structural design of adding a speaker. The housing and lamp body of original solar atmosphere lamp are connected to the connection frame, the connection frame is connected to an insertion rod so that it can be installed outdoors. The solar cell assembly is installed inside the housing, and the luminous component is installed on the support platform of the lamp body. By adding decorations on the lamp body, the atmosphere is created visually. After improvement, the speaker is added to the structure of the original solar atmosphere lamp to play sound, further enhancing the atmosphere experience from the auditory aspect. This not only enhances the user's atmosphere experience, but also breaks through the traditional wired connection, rendering music playback more convenient and economical.

2. This scheme stores music in advance in the control component. After turning on the switch, on the one hand, the control component controls the rechargeable battery to store the electricity converted by the solar panel during the day and controls the rechargeable battery to stop supplying power to the speaker and luminous component. At night, the control component controls the rechargeable battery to supply power to the speaker and automatically play music and light up the luminous component. On the other hand, the music stored in the control component can be replaced according to the user's different experiences, achieving the effect of simplifying and energy-saving of the control for the solar atmosphere light, which meets different user needs, and adapts to different outdoor scenarios to create the atmosphere.

### BRIEF DESCRIPTION OF DRAWINGS

In order to provide a clearer explanation of the technical solution in the embodiments of the present application, a brief introduction will be made to the accompanying drawings required in the description of the embodiments. It is obvious that the accompanying drawings are only some embodiments of the present application. For those skilled in the art, other accompanying drawings can be obtained based on these drawings without creative work.

FIG. 1 is a structural schematic diagram of an embodiment of the present disclosure.

FIG. 2 is a structural schematic diagram corresponding to a certain direction in FIG. 1.

FIG. 3 is an exploded view of a partial structure of a support seat.

FIG. 4 is a structural exploded view of the support seat.

FIG. 5 is a structural exploded diagram corresponding to a certain direction in FIG. 4.

FIG. 6 is a structural schematic diagram of a lamp body.

FIG. 7 is a circuit diagram of a corresponding control component.

### DESCRIPTION OF EMBODIMENTS

The following will provide a clear and complete description of the technical solution in the embodiments of the present disclosure, in combination with the accompanying drawings. Obviously, the described embodiments are only a part of the embodiments of the present disclosure, not all of them. Based on the embodiments in the present disclosure, all other embodiments obtained by those skilled in the art without creative work within the protection scope of the present disclosure.

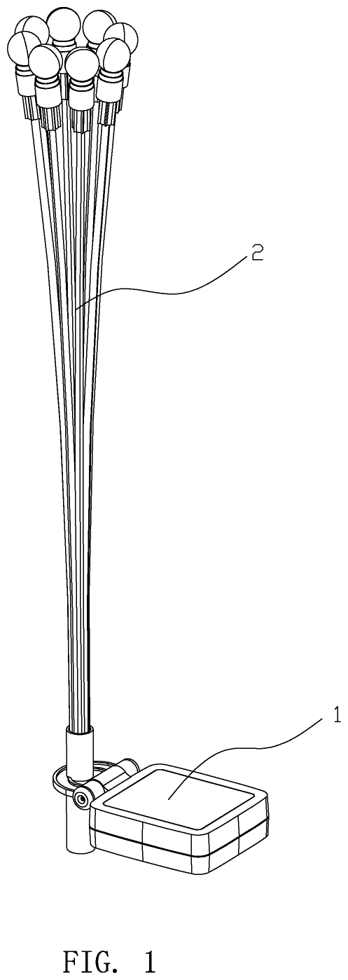

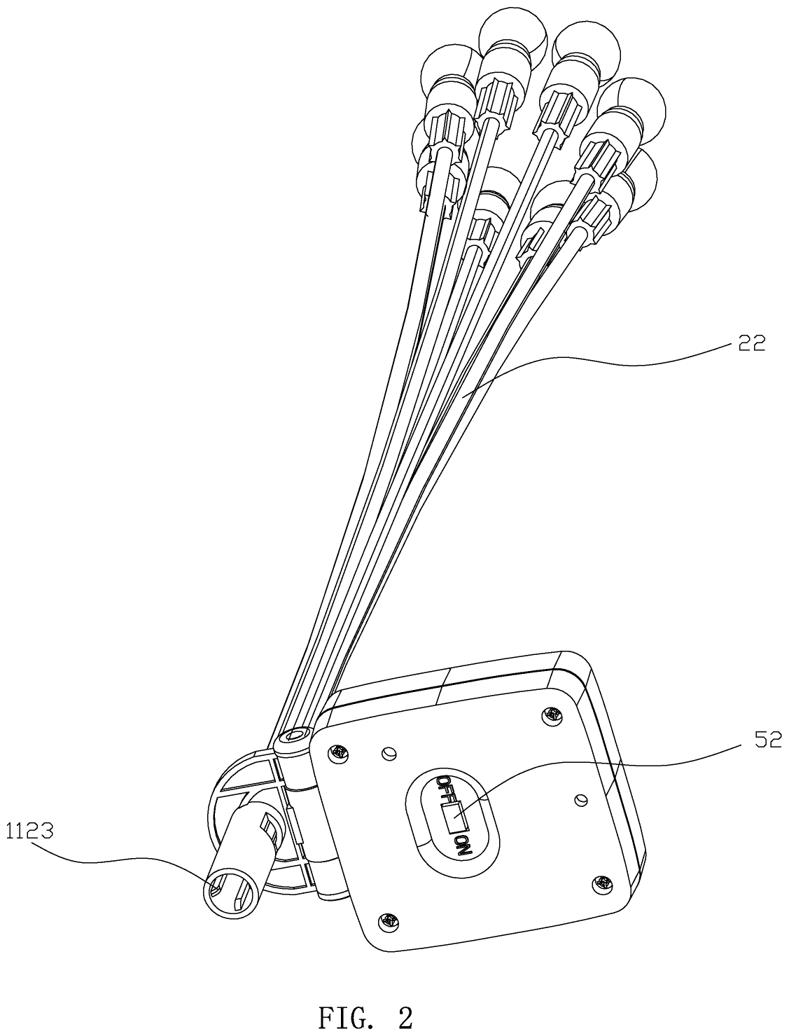

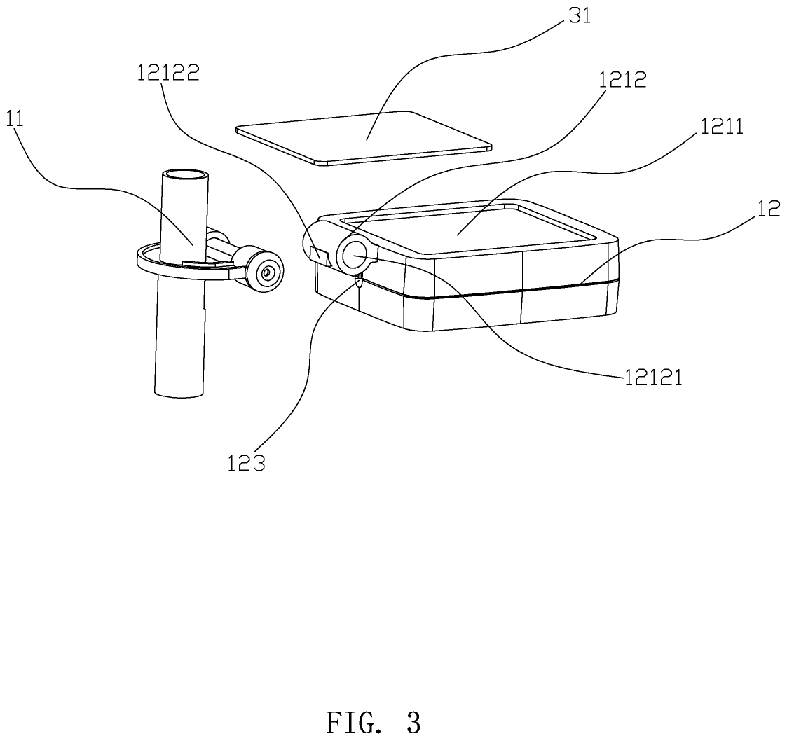

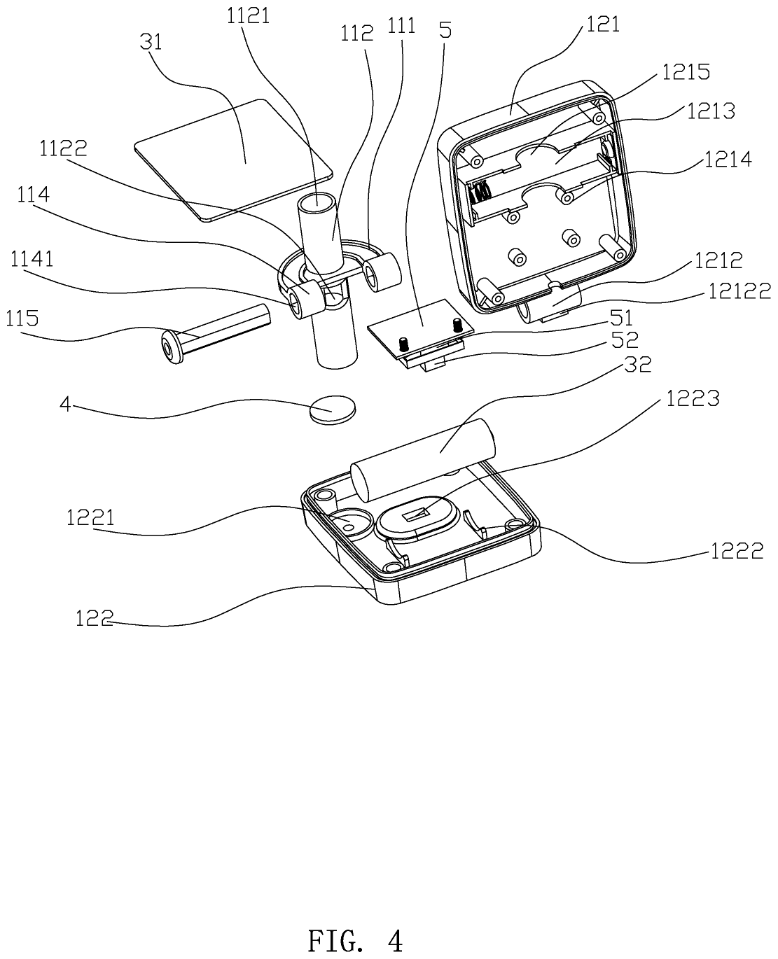

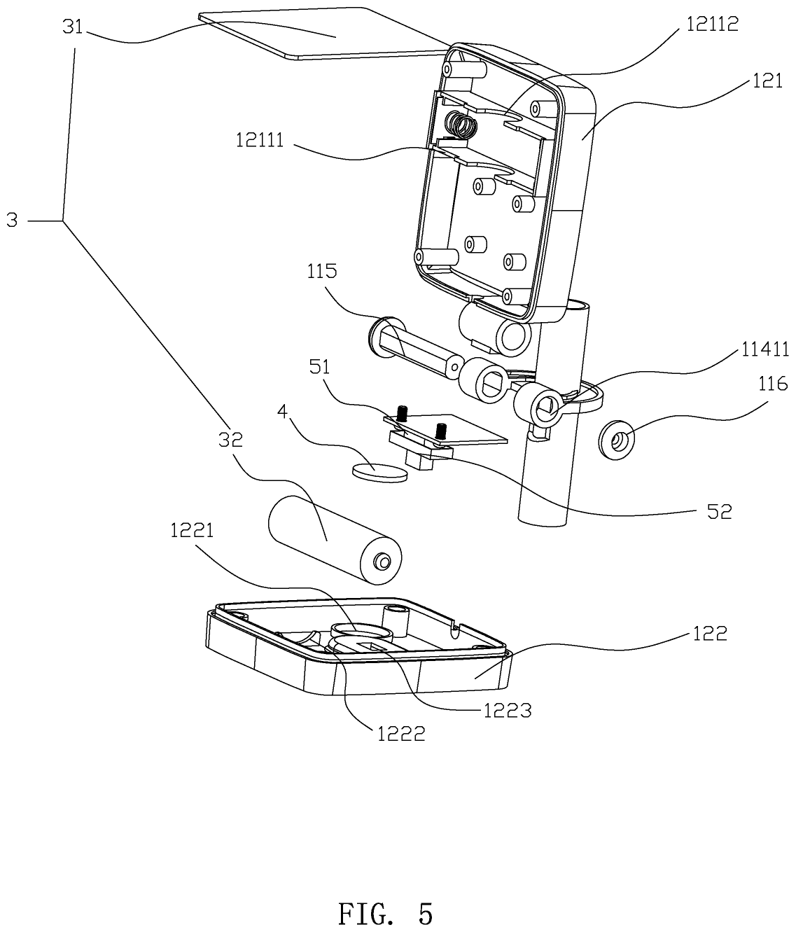

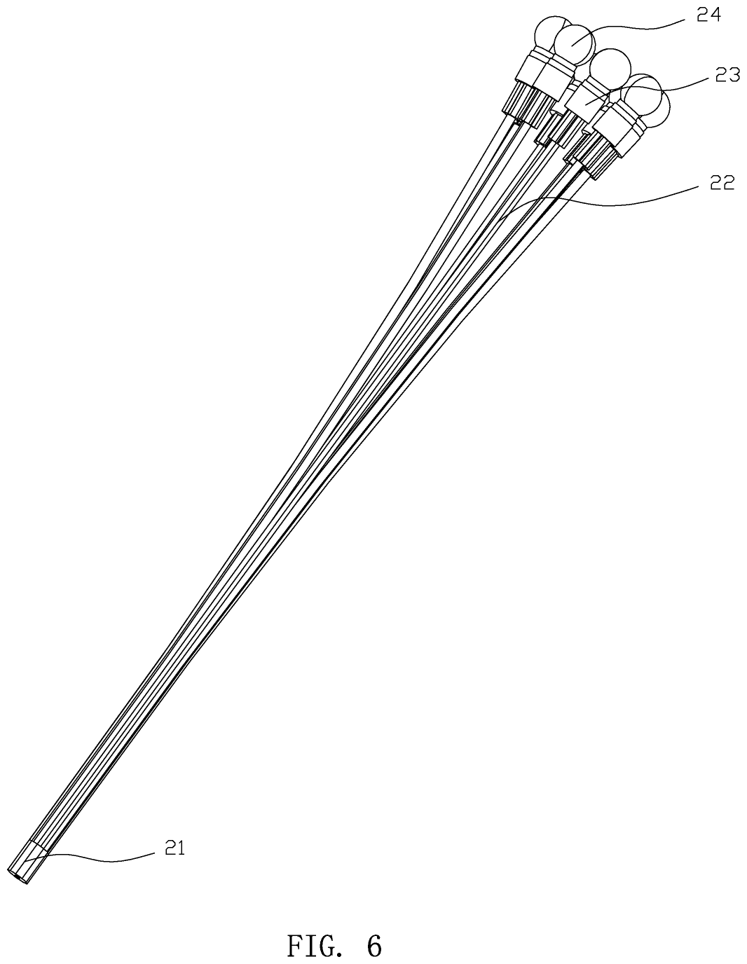

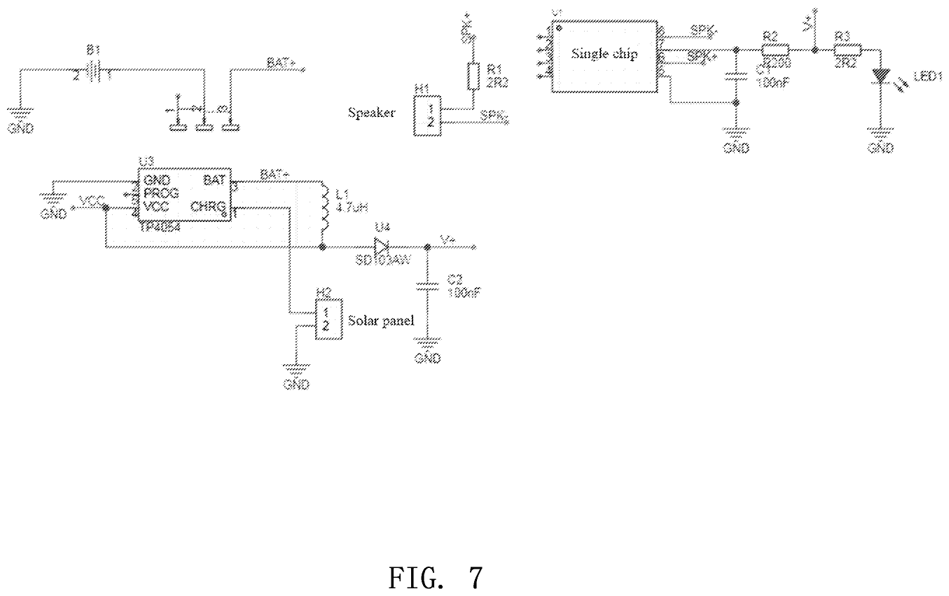

As shown in FIGS. 1 to 7, an embodiment of the present disclosure provides a solar atmosphere lamp with a speaker, including:
a support seat 1, including a connection frame 11 and a housing 12, the housing 12 is connected to the connection frame 11, the connection frame 11 is connected to an insertion rod to stabilize the support seat 1;
a lamp body 2, which is provided with a support platform 23 and a luminous component 24; the support platform 23 is configured to install the luminous component 24, and the lamp body 2 is connected to the connection frame 11;
a solar cell assembly 3, which is connected to the housing 12, and the solar cell assembly 3 is provided with a solar panel 31 and a rechargeable battery 32, the rechargeable battery 32 is connected to the solar panel 31 for charging;
a speaker 4, which is connected to the housing 12 for playing sound.

Specifically, the luminous component 24 is an LED bead, the lamp body 2 further includes a header pip platform 21 and a protective tube 22; the support platform 23 is fixedly connected to the protective tube 22, which can support the support platform 23 and also provide protection for connection wires of the luminous component 24 to access; the protective tube 22 is fixedly connected to the header pip platform 21, and the header pip platform can fix a low of the protective tube 22 to produce different bending effects by using different materials under an action of gravity. The header pip platform 21 is fixedly connected to the support seat 1 to maintain a connection position of the lamp body 2 to be stable.

In an implementation, the housing 12 can be detachably connected to the connection frame 11 to enable folding and storing the solar atmosphere lamp with a speaker, thereby reducing a required storage space.

In an implementation, the connection frame 11 is provided with a connecting platform 111 and a connecting column 112. The connecting column is provided with a first through hole 1121 and a wire slot 1122. A lower of the first through hole 1121 is provided with a stabilizing block 1123. The stabilizing block 1123 has the functions of limiting an installation depth of the header pip platform 21 in the first through hole 1121, facilitating a quick installation of the insertion rod, and ensuring a stability of the insertion rod after installation; the wire slot 1122 can be used for connecting wires of luminous component 24 to access. The wire slot 1122 is designed to protect the connecting wires, which can prevent the connecting wires from being exposed to sunlight or moisture for a long time and shorten its service life. The connecting platform 111 is integrally formed and connected to the connecting column 112 to ensure the stability of an overall structure of the support seat 1.

In an implementation, the connecting platform 111 is a U-shaped with a central opening. The connecting platform 111 is provided with a connecting column 114, a connecting lock column 115, and a locking component 116. The connecting column 114 is provided with a locking column hole 1141, both sides of the connecting column 114 and the locking column hole 1141 are planar surfaces. A locking installation hole 11411 of the connecting column 114 is designed to be circular. The connecting lock column 115 is connected to the connecting platform 111 through the locking column hole 1141, the locking component 116 is installed at the locking installation hole 11411 to lock the connecting lock column 115 to fix the housing 12. This design allows the housing 12 to rotate relative to the connecting lock column 115, and the housing 12 can be stable at a certain angle and facilitate the installation of the locking component 116.

In an implementation, the housing 12 includes an upper housing 121 and a lower housing 122, as well as a wire hole 123. The upper housing is connected to the connecting platform 111, the lower housing 122 is fixedly connected to the upper housing 121. The wire hole 123 can be used for connecting wires of lamp beads to access. This design facilitates a quick assembly of the protective connection wires and the housing 12, as well as a mass production of the product in factory.

In an implementation, the upper housing 121 is provided with a solar panel groove 1211, a connecting end column 1212, a battery groove 1213, and a fixing column 1214. The solar panel 31 is fixedly connected to the solar panel groove 1211, a disconnecting groove 12111 is provided on a side of the solar panel groove 1211. The disconnecting groove 12112 facilitates the disconnection of the solar panel groove 1211. A control component 5 is fixedly connected to the upper housing 121 through the fixing column 1214, which can prevent the control component 5 from shaking during a rotation of the housing 12. The connecting end column 1212 is provided with a second through hole 12121 and a block 12122 that can abut again the connecting platform. The second through hole 12121 can be hinged to the connection frame 11 through the connecting lock column 115, and the rotary top block 12122 can be clamped to the connecting platform 111. This design can prevent an excessive rotation of the housing 12 and provide a reaction force to maintain a structural stability of the housing 12 when the housing 12 is fully unfolded.

In an implementation, the lower housing 122 is provided with a speaker slot 1221, a battery clamp block 1222, and a switch slot 1223. The speaker 4 is fixedly installed in the speaker slot 1221 to prevent it from falling during the rotation of the housing 12. The battery clamp block 1222 is designed to be in a shape that simulates a battery, which can further well fix the rechargeable battery 32 in the battery slot 1213. An operation switch 51 is connected externally through the switch slot 1223 for easy control of circuit switches.

In an implementation, the luminous component 24 and the speaker 4 are controlled to emit light and play sound by the control component 5. The control component 5 is provided with an operation switch 51 and a single chip control module. The single chip control module can store music and control the solar cell assembly 3, the luminous component 24, and the speaker 4. The operation switch 51 is installed in the switch slot 1223. After staring the operation switch 51, the control component 5 automatically controls the solar cell assembly 3 to store and convert electrical energy during the day, and the luminous component 24 and the speaker 4 to stop working. At night, it automatically controls the rechargeable battery 32 to supply power to the luminous component 24 and the speaker 4 to make them work. The luminous component 24 lights up and the speaker 4 plays music.

In an implementation, the operation switch 51 is provided with a waterproof film 52, in an implementation mode, which is made of polyethylene material. The operation switch 51 is wrapped and sealed in the switch slot 1223 through the waterproof film 52, which can better prevent external water flow from entering the housing 12.

It should be understood that terms “first”, “second”, etc. are used in the present disclosure to describe various information, but this information should not be limited to these terms, and these terms are only used to distinguish the same type of information from each other. For example, without departing from the scope of the present disclosure, “first” information can also be referred to as “second” information, and similarly, “second” information can also be referred to as “first” information. In addition, terms “center”, “up”, “down”, “left”, “right”, “vertical”, “horizontal”, “inside”, “outside”, etc. indicate an orientation or position relationship based on the orientation or position relationship shown in the drawings, only for a convenience of describing the present disclosure and simplifying the description, rather than indicating or implying that the device or component referred to must have a specific orientation, be constructed and operated in a specific orientation, and therefore cannot be understood as a limitation on the present disclosure.

The above is preferred embodiments of the present disclosure. It should be noted that for those skilled in the art, several improvements and deformations can be made without departing from the principles of the present disclosure. These improvements and deformations are also considered as the protection scope of the present disclosure.

1. A solar atmosphere lamp with a speaker, comprising:
a support seat, which comprises a connection frame and a housing, wherein the housing is connected to the connection frame, the connection frame is connected to an insertion rod to stabilize the support seat;
a lamp body, which is provided with a plurality of support platforms and a plurality of luminous components, the support platforms are configured to install the luminous components, the lamp body is connected to the connection frame;
a solar cell assembly, which is connected to the housing, and the solar cell assembly is provided with a solar panel and a rechargeable battery, the rechargeable battery is connected to the solar panel for charging;
a speaker, which is connected to the housing for playing sound;
wherein the lamp body further comprises a header pip platform and a plurality of protective tubes, the support platforms are fixedly connected to the protective tubes, the protective tubes are fixedly connected to the header pip platform, and the header pip platform is fixedly connected to the support seat to maintain a connection position of the lamp body to be stable;
wherein the connection frame is provided with a connecting platform and a connecting column, wherein the connecting column is provided with a first through hole and a wire slot, a lower of the first through hole is provided with a stabilizing block.

2. (canceled)

3. The solar atmosphere lamp with a speaker as claimed in claim 1, wherein the housing can be detachably connected to the connection frame so that the housing can be folded and stored.

4. The solar atmosphere lamp with a speaker as claimed in claim 1, wherein the wire slot is configured for connecting wires of the luminous components to access, and the connecting platform is fixedly connected to the connecting column.

5. The solar atmosphere lamp with a speaker as claimed in claim 4, wherein the connecting platform is provided with a connecting column, a connecting lock column, and a locking component; the connecting column is provided with a locking column hole, and the connecting lock column is connected to the connecting platform through the locking column hole, the connecting lock column is locked by the locking component to fix the housing.

6. The solar atmosphere lamp with a speaker as claimed in claim 1, wherein the housing comprises an upper housing and a lower housing, and a wire hole; the upper housing is connected to the connecting platform, the lower housing is fixedly connected to the upper housing, and the wire hole is configured for connecting wires of lamp beads to access.

7. The solar atmosphere lamp with a speaker as claimed in claim 6, wherein the upper housing is provided with a solar panel groove, a connecting end column, a battery groove, and a fixing column; the solar panel is fixedly connected to the solar panel groove, the rechargeable battery is detachably connected to the battery groove, a control component is fixedly connected to the upper housing through the fixing column, and the connecting end column is provided with a second through hole, the second through hole can be hinged to the connection frame through the connecting lock column.

8. The solar atmosphere lamp with a speaker as claimed in claim 6, wherein the lower housing is provided with a speaker slot, a battery clamp block, and a switch slot; the speaker is fixedly installed in the speaker slot, the battery clamp block can further fix the rechargeable battery in the battery groove.

9. The solar atmosphere lamp with a speaker as claimed in claim 1, wherein the luminous components and the speaker are controlled to emit light and play sound by the control component, the control component is provided with an operation switch that is installed in the switch slot.

10. The solar atmosphere lamp with a speaker as claimed in claim 9, wherein the operation switch is provided with a waterproof film.
